(19) United States
(12) Patent Application Publication
(10) Pub. No.: US 2016/0219830 A1
(43) Pub. Date: Aug. 4, 2016

(54) ANIMAL CLEAR NESTING MATERIAL

(71) Applicants: Greg Boivin, Springboro, OH (US); Henry Daniel Young, Dayton, OH (US)

(72) Inventors: Greg Boivin, Springboro, OH (US); Henry Daniel Young, Dayton, OH (US)

(73) Assignee: Wright State University, Dayton, OH (US)

(21) Appl. No.: 15/014,496

(22) Filed: Feb. 3, 2016

Related U.S. Application Data
(60) Provisional application No. 62/111,339, filed on Feb. 3, 2015.

(51) Int. Cl. A01K 1/015; B31F 1/20; B31D 5/02; B31F 1/08

(52) U.S. Cl. CPC A01K 1/0155; B31F 1/08; B31F 1/20; B31D 5/02

(57) ABSTRACT

Systems, methods, and other embodiments associated with clear nesting material for animals. According to one embodiment, the clear nesting material comprises a clear polymer material such that an animal inside of a nest constructed of the clear nesting material is visible.

### CROSS-REFERENCE TO RELATED APPLICATIONS

This application claims the benefit of U.S. Provisional Patent Application Ser. No. 62/111,339 entitled “Small Animal Translucent Nesting Material” filed on Feb. 3, 2015. The entirety of the above-noted applications is incorporated by reference herein.

### BACKGROUND

Several regulations guide the care and use of laboratory animals, such as small animals (e.g., mice, rats, guinea pigs, hamsters, gerbils, shrews, voles, etc.) in research facilities. These regulations require that animals used in research be examined daily to ensure the health of the animals. Researchers are also obligated to provide environmental enrichment for the animals. Accordingly, researchers provide nesting material so that the small animals are able to manipulate or alter their surroundings. Alternatively, researchers may use a structure for environmental enrichment, such as a plastic hut. The plastic hut, however, does not allow for thermal regulation by the small animals, cannot be manipulated by the animals, and thus, is considered to be an inferior response to the environmental enrichment obligation.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

As discussed above, nesting material is an acceptable form of environmental enrichment for animals. A common complication of using traditional nesting material is the inability to visualize an animal when the animal is in the nest. Nesting materials are typically opaque. For example, the nesting material may be a white or brown paper product. The paper nest material is compliant and allows manipulation by the animals, and allows for thermoregulation of the nest. Alternatively, the nesting material may be a cotton square that animals are able to shred. Whether using a paper product or cotton squares, visualization of the animal in the nest is difficult and in some cases not possible without opening the cage or manipulating the nest. Thus, the regulations that require research institutions to observe animals daily becomes very difficult to fulfill because it may be necessary to disturb the habitat or nest to achieve adequate visualization. Inadequate visualization becomes a financial issue for the research institution because the technical staff responsible for performing the observations takes longer to observe the animals.

Described herein are examples of systems, methods, and other embodiments associated with animal clear nesting material. In one embodiment, the clear nesting material is fabricated from a polymer material. The clear nesting material provides enrichment and allows visualization of the animals in undisturbed nests. This saves the technical staff time, and consequently, the research institution money, as well as improves animal welfare.

In an aspect of the innovation, a nesting material for animals is provided that includes a clear material, wherein an animal on an opposite side of the clear material is visible, wherein the clear material is made from a translucent and/or transparent material, and wherein the translucent and/or transparent material is a polymer material.

The following description and drawings set forth certain illustrative aspects and implementations. These are indicative of but a few of the various ways in which one or more aspects may be employed. Other aspects, advantages, or novel features of the disclosure will become apparent from the following detailed description when considered in conjunction with the drawings.

### BRIEF DESCRIPTION OF THE DRAWINGS

The accompanying drawings, which are incorporated in and constitute a part of the specification, illustrate various systems, methods, and other embodiments of the disclosure. Illustrated element boundaries (e.g., boxes, groups of boxes, or other shapes) in the figures represent one example of the boundaries. In some examples one element may be designed as multiple elements or multiple elements may be designed as one element. In some examples, an element shown as an internal component of another element may be implemented as an external component and vice versa.

FIG. 1 illustrates one embodiment of prior art animal bedding in accordance with an aspect of the innovation.

FIG. 2A illustrates an embodiment of animal clear nesting material in accordance with an aspect of the innovation.

FIG. 2B illustrates another embodiment of animal clear nesting material in accordance with an aspect of the innovation.

FIG. 3 shows example weight data of the mice housed with the different nest materials in accordance with an aspect of the innovation.

FIG. 4 is an illustration of a visibility table that scores the visibility of each type of nesting material in accordance with an aspect of the innovation.

FIG. 5 is a bar graph illustrating an average nest score of each nesting material for each strain of mice in accordance with an aspect of the innovation.

FIG. 6 is a bar graph illustrating a fecal corticosterone level in accordance with an aspect of the innovation.

FIG. 7 illustrates one embodiment of a method associated with animal clear nesting material in accordance with an aspect of the innovation.

### DETAILED DESCRIPTION

Embodiments or examples illustrated in the drawings are disclosed below using specific language. It will nevertheless be understood that the embodiments or examples are not intended to be limiting. Any alterations and modifications in the disclosed embodiments and any further applications of the principles disclosed in this document are contemplated as would normally occur to one of ordinary skill in the pertinent art. Described herein are examples of systems, methods, and other embodiments associated with animal clear nesting materials. Animal as described herein may include small, medium, and large animals. Further, small animals may include laboratory animals, such as but not limited to mice, rats, guinea pigs, hamsters, gerbils, shrews, voles, etc. in research facilities. It is to be understood that the scope of the innovation is not limited to the size of the animal. Thus, the example embodiment described herein and illustrated in the figures is for illustrative purposes only and is not intended to limit the scope of the innovation.

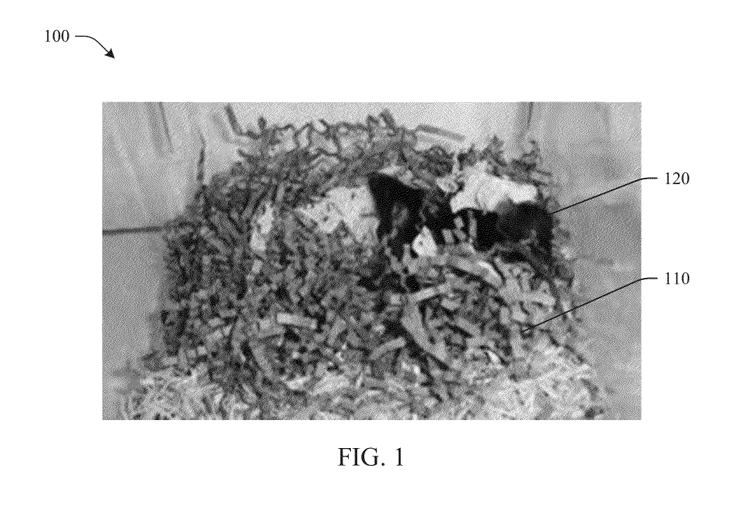

Referring now to the drawings, FIG. 1 illustrates one embodiment of prior art animal bedding used to build a nest 100. The nest 100 is constructed from an opaque nesting material 110. The nest 100 is concealing an animal 120. In one embodiment, the opaque nesting material 110 is a paper product. In other embodiments, the opaque nesting material may be cotton shred, corn cob bedding, wood chips, wood shavings, hemp fiber, hay, or straw. As can be seen, the animal 120 is difficult to see in the nest 100 due to the opacity of the opaque nesting material 110. Accordingly, it is difficult to monitor the health of the animal 120.

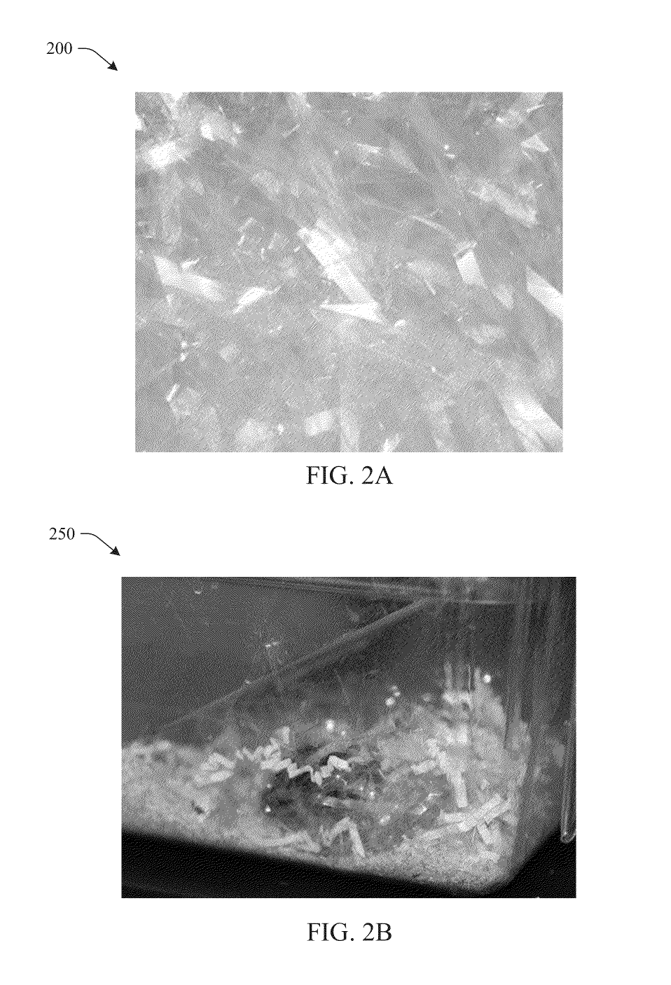

FIG. 2A illustrates one embodiment of animal clear nesting material 200 in accordance with an aspect of the innovation. Clear is defined herein as allowing the passage of light through the material so that objects can be seen on the other side of the material. Thus, as described herein, the clear nesting material 200 is defined as allowing the passage of light through the nesting material, which can include a translucent nesting material, a transparent nesting material, or a combination of both translucent and transparent nesting materials. In one embodiment, the clear nesting material 200 may be a clear polymer material in sheet form. For example, the clear nesting material 200 may be cellophane or cellophane vellum composite. Alternatively, the clear nesting material 200 may be a polyvinylidene chloride (PVDC) material (e.g., a homopolymer of vinylidene chloride), polyethylene (PE), polythene (IUPAC), polyethene, or poly (methylene). While these are the most common plastics, other clear materials may be used to construct the clear nesting material 200.

In addition to visualizing an animal, the clear nesting material 200 may also aid in the visualization of bodily fluids. For example, when an animal urinates or defecates, it is possible to see the urine, or feces. Additionally, in one embodiment, the clear nesting material 200 may have a coating that causes a visual characteristic of the clear nesting material to change in the presence of a secretion. For example, in the presence of purulent exudate or other difficult to visualize secretion, the coating may cause a visual characteristic of the clear nesting material to change, such as the color of the clear nesting material. In another embodiment, the clear nesting material may change size or shape.

The clear nesting material 200 may be fragmented into a number of pieces, such that animals are able to manipulate the clear nesting material 200. For example, an animal may build a nest with the clear nesting material 200. In one embodiment, the clear nesting material 200 may be shredded or cut into pieces. For example, clear sheets of cellophane may be machine shredded. The size of the pieces may be based on the size of the animal. The clear nesting material 200 may also be textured. For example, the clear nesting material 200 may have a crinkle or netted texture. Alternatively, the clear nesting material 200 may be embossed to form a pattern.

To evaluate the suitability of the clear nesting material, twelve mice were examined for their ability to make a quality nest with the clear nesting material. Specifically, the twelve mice were paired and placed in cages. In the first two habitats, the mice were given opaque nesting material. In the second two habitats, the mice were given clear nesting material. In the third two habitats, the mice were given a mixture of opaque nesting material and clear nesting material. The suitability of the nesting material was measured by observing how the mice used their nesting material. The measurement was assessed using a naturalistic nest scoring key described by Hess, et al. (http://www.ncbi.nlm.nih.gov/pmc/articles/PMC2687128/pdf/jaalas2008000025.pdf).

Specifically, an undisturbed nest is assigned a 0, a disturbed nest is assigned a 1, a flat nest is assigned a 2, a cup shaped nest is assigned a 3, an incomplete dome nest is assigned a 4, and a complete dome nest is assigned a 5. Results of testing nest quality of the clear nesting material in comparison to traditional nesting materials or a mix of traditional and clear materials showed no significant differences (Table 1).

| Nest | Average Nest | Standard |
|---|---|---|
| Material | Score | Deviation |
| Clear | 2.73 | 1.08 |
| White Paper | 2.73 | 0.87 |
| Mix | 3.06 | 1.07 |

Specifically, nest quality scores were similar for the mice using the clear nesting material as compared to the mice using the mixed nesting material. The mice also used the clear nests just as frequently as the mixed or opaque nests. Mice were in the nest 90%, 86% and 85% of the time with the clear, mixed or opaque nest material, respectively at time of observations. Furthermore, visualization of the mice was improved when using the clear or mixed nesting material. The mice in the clear nest material were visible over 97% of the time, whereas the mice in the opaque nest were visible only 63% of the time while in the nest. Accordingly, use of the clear nesting material would allow better health assessments of the mice, will also save the technical staff time, and consequently, the research institution money.

FIG. 2B illustrates another embodiment of animal clear nesting material. Specifically, FIG. 2B illustrates a mouse in a nest 250 having a mixture of opaque nesting material and clear nesting material.

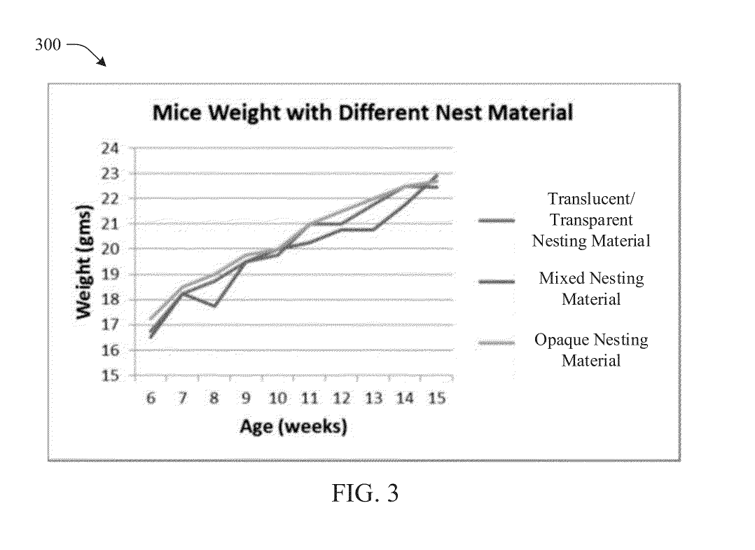

FIG. 3 is a graph illustrating a weight gain 300 of the mice housed with the different nest material. As illustrated, the mice steadily gained weight. There, however, was no significant difference in the weight gain of the mice between the different nesting materials.

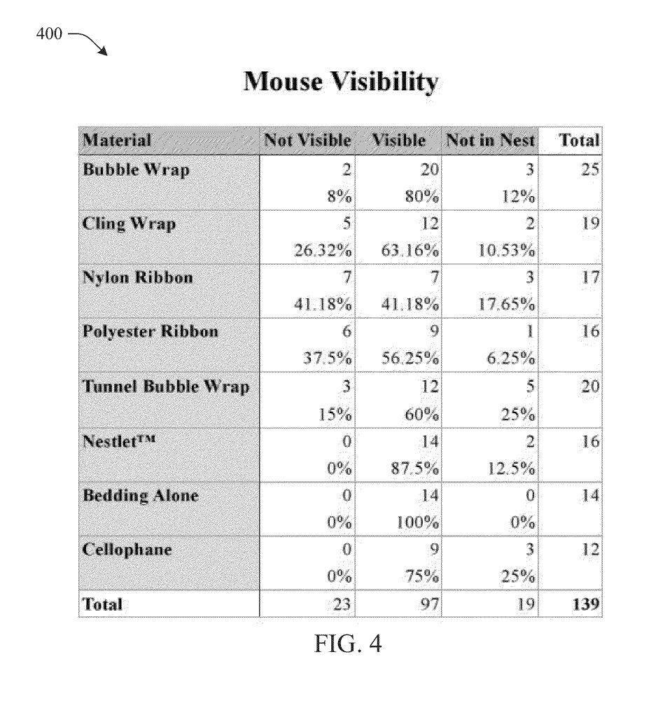

Referring to FIGS. 4-6, in another evaluation to evaluate the suitability of the clear nesting material, 24 mice, 12 from a first strain (C57BL/6 mice, hereafter called “strain A”) and 12 from a second strain (BALB/c mice, hereafter called “strain B”), were examined for their ability to make a quality nest with the clear nesting material. Specifically, the mice were paired and placed in cages. Each pair of mice received either, bubble wrap (polyethylene film), cling wrap (polyvinyl chloride), polyester ribbon, nylon ribbon, cellophane shred, tunnel-shaped bubble wrap, cotton Nestlet™, or no nesting material. The suitability of the nesting material was measured by observing how the mice used their nesting material. Other materials may include shrink wrap (polyolefin) and tulle (nylon). The nesting material may be shredded, cut into strips (e.g., 1-2 cm wide by 10-50 cm in length), may be in the form of a pouch, may be sheets, etc.

The following parameters were followed during the testing process: the nests were scored twice a week using a naturalistic nest scoring key described by Hess, et al and ranked on a 0-5 scale; the mouse body weights were recorded weekly; the cages were replaced with clean bedding and nesting material weekly; the mice received a different nesting material every two weeks; after two weeks with the nesting material, fecal samples were collected; and corticosterone as says were assessed using Arbor Assays Corticosterone Enzyme Immunoassay kits.

FIG. 4 is an illustration of a visibility table 400 that scores the visibility of each type of nesting material. The top number in each row is the number of observations conducted for each nesting material over a given period of time. Thus, there were 139 observations conducted in total for all nesting materials. The bottom number is the percentage that the mice were either not visible, visible, or not in the nest.

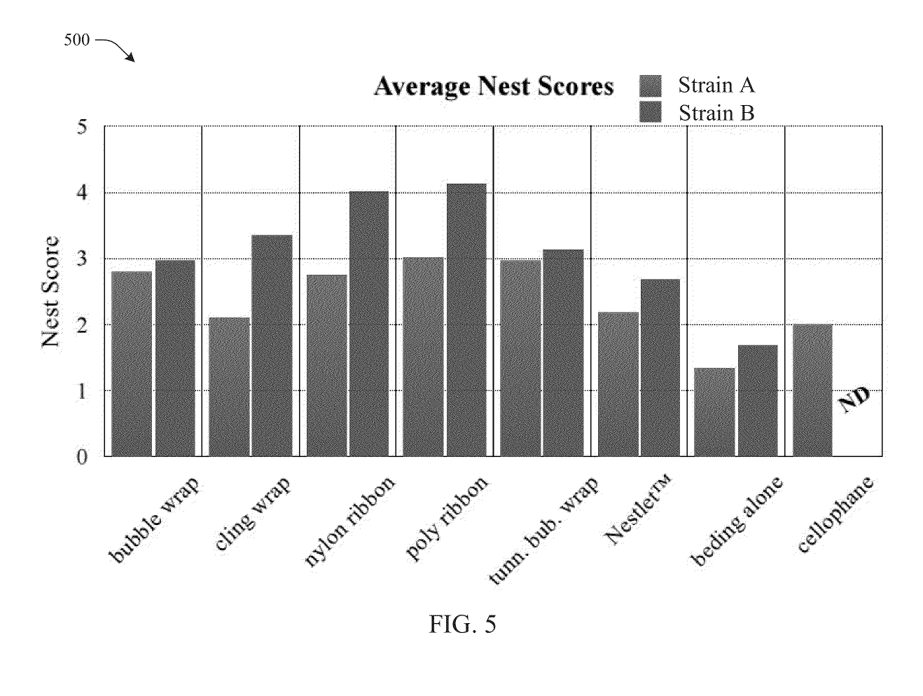

FIG. 5 is a bar graph illustrating an average nest score 500 of each nesting material for each strain of mice tested.

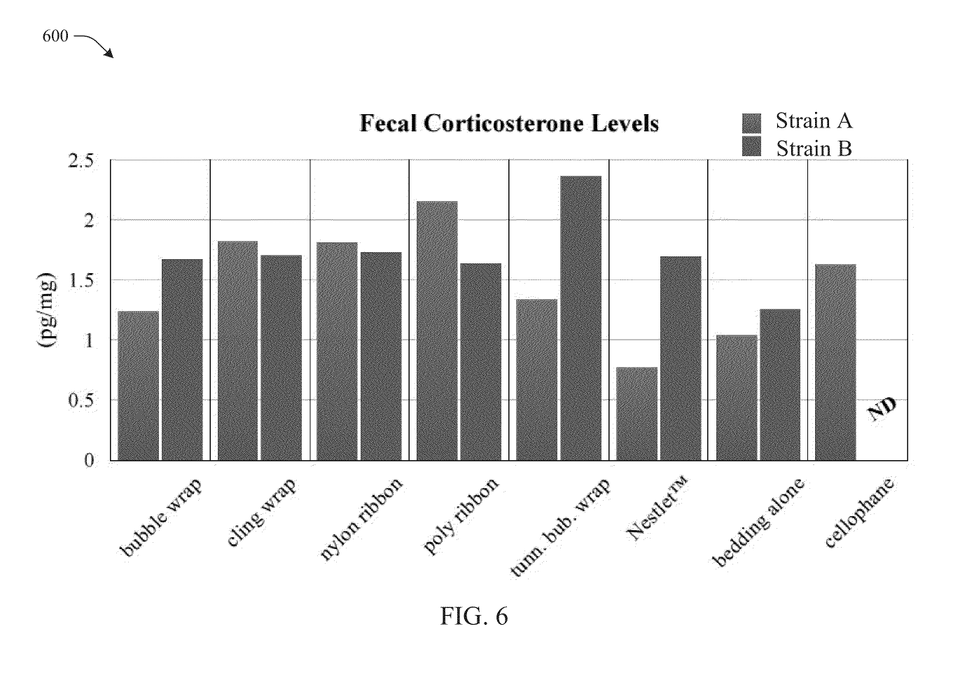

FIG. 6 is a bar graph illustrating a fecal corticosterone level 600, which illustrates that there were no significant differences found between the corticosterone levels of the mice based on nesting materials.

In addition, the results demonstrate that the differences in weight gain were not significant between mice using different nesting materials, as demonstrated by the evaluation described above and illustrated in FIG. 3. Thus, the nesting materials tested in the evaluations may be substituted for opaque materials with no known negative consequences to animal health.

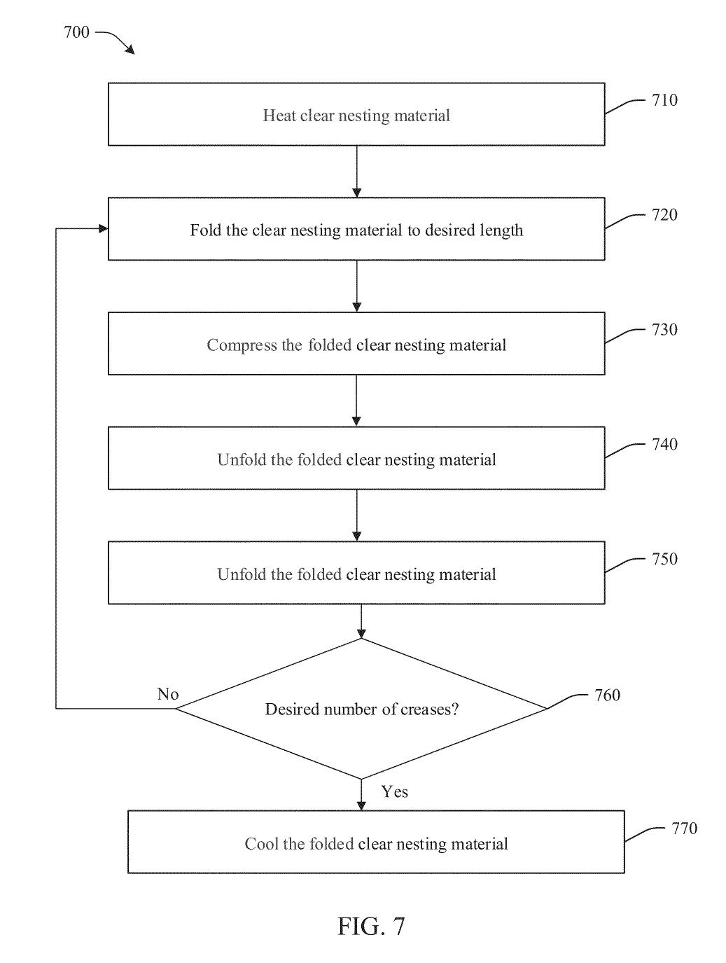

FIG. 7 illustrates one embodiment of a method 700 associated with animal clear nesting material. A clear nesting material may require processing. For example, animals may find the clear nesting material easier to manipulate if the clear nesting material has creases. Accordingly, in one embodiment, method 400 is used to crease the clear nesting material.

At 710, the clear nesting material is heated until it is pliable. At 720, the clear nesting material is folded to the desired length. The desired length may be based on the size of the animal intended to manipulate the clear nesting material. Specifically, the clear nesting material is folded to form a crease. At 730, the clear nesting material is compressed while it is warm to stabilize the crease. At 740, the folded clear nesting material is unfolded. At 750, the clear nesting material is cut to a desired width. At 760, it is determined whether the clear nesting material has the desired number of creases. If the clear nesting material does not have the desired number of creases, the method 700 returns step 720 and the method is repeated to create more creases. Conversely, if the clear nesting material does have the desired number of creases, the method 700 proceeds to 770. At 770, the clear nesting material is cooled so that the creases are able to set.

Accordingly, heat and compression are used to better form the clear nesting material into a molded form that has more folds so that the material has increased memory and stiffness, is better shaped for manipulation by animals, and can more easily be integrated into a complex, three dimensional nest structure. The clear nesting material may not naturally retain shape when folded, but because the clear nesting material is heated and folded, the creases in the clear nesting material are maintained once the clear nesting material has cooled. Accordingly, the clear nesting material allows an animal to build a nest and still be seen when the animal is in the nest.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

While for purposes of simplicity of explanation, illustrated methodologies are shown and described as a series of blocks. The methodologies are not limited by the order of the blocks as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks. The methods described herein is limited to statutory subject matter under 35 U.S.C §101.

To the extent that the term “includes” or “including” is employed in the detailed description or the claims, it is intended to be inclusive in a manner similar to the term “comprising” as that term is interpreted when employed as a transitional word in a claim. As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

Although the disclosure has been shown and described with respect to one or more implementations, equivalent alterations and modifications will occur based on a reading and understanding of this specification and the annexed drawings.

What is claimed is:

1. A nesting material for animals comprising:
a clear material, wherein an animal on an opposite side of the clear material is visible.

2. The nesting material of claim 1, wherein the clear material is made from a translucent and/or transparent material.

3. The nesting material if claim 2, wherein the translucent and/or transparent material is a polymer material.

4. The nesting material of claim 3, wherein the polymer material has a texture.

5. The nesting material of claim 3, wherein the polymer material is crinkled.

6. The nesting material of claim 3, wherein the polymer material has a coating, and wherein the coating indicates the presence of bodily fluids by altering a visual characteristic of the polymer material.

7. The nesting material of claim 6, wherein the visual characteristic is a color of the polymer material.

8. The nesting material of claim 6, wherein the visual characteristic is a shape or size of the polymer material.

9. A method for creasing clear nesting material comprising:
heating a clear nesting material;
folding the clear nesting material to a desired length based, at least in part on, the size of an animal intended to manipulate the clear nesting material;
compressing the folded clear nesting material;
unfolding the folded clear nesting material; and
cooling the unfolded clear nesting material.

10. The method of claim 9, wherein the clear nesting material is made from a translucent and/or transparent polymer material.

11. The method of claim 10, wherein the clear nesting material is crinkled.

12. The method of claim 10 further comprising:
the clear nesting material interacting with a secretion of the animal; and
changing a visual characteristic of the clear nesting material based, at least in part, on the interaction of the clear nesting material and the secretion.

13. The method of claim 12, wherein the visual characteristic is a color of the clear nesting material.

14. The method of claim 12, wherein the visual characteristic is a shape or size of the clear nesting material.

15. A nesting material for animals comprising:
a clear material,
wherein the clear material is fragmented into pieces, and
wherein a size of the fragmented pieces is based, at least in part on, the size of an animal intended to manipulate the clear material.

16. The nesting material of claim 15, wherein the clear material is made from a translucent and/or transparent material.

17. The nesting material if claim 16, wherein the translucent and/or transparent material is a polymer material.

18. The nesting material for animals of claim 15, wherein the clear material has a texture.

19. The nesting material for animals of claim 15, wherein the clear material is crinkled.

20. The nesting material for animals of claim 15, wherein the clear material has a coating, and wherein the coating indicates the presence of bodily fluids by altering a visual characteristic of the clear material.

21. The nesting material for animals of claim 20, wherein the visual characteristic is a color of the clear material.
